(19) United States
(12) Patent Application Publication
(10) Pub. No.: US 2011/0212284 A1
(43) Pub. Date: Sep. 1, 2011

(54) Stretcher Stopper

(76) Inventor: Jerry Joseph Montone, Bradenton, FL (US)

(21) Appl. No.: 12/931,742

(22) Filed: Apr. 13, 2009

(51) Int. Cl. B32B 3/02; B32B 7/12

(52) U.S. Cl. 428/40.1; 428/80; 428/220; 428/343

(57) ABSTRACT

A floor mounted stopping device having an oblong solid material: a bottom surface and a double sided high bonding adhesive tape affixed on one side to the bottom surface; a peal away backing affixed to the other side of the double sided high bonding adhesive tape; the oblong solid material is shaped as a triangle across its length; the oblong solid material is shaped as a triangle on two end sides; the length of the floor mounted stopping device is greater than the distance between two wheels of a device; the width of the floor mounted stopping device is such that is prepared to stop wheeled devices; the oblong solid material has a triangular design with a flat bottom and angles inward from a rounded or flat edge base running the length of the device; the material is made from: plastic, rubber, vinyl, metal, elastomeric materials, PVC, wood and polymers.

### CROSS REFERENCE TO RELATED APPLICATIONS

N/A

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the United States Patent and Trademark Office patent file or records, but otherwise reserves all copyrights whatsoever.

### BACKGROUND

(1) Field of the Invention

Relating to improvements in the operation of stretchers. More specifically, relating to improvements in the restriction of stretcher motion.

(2) Related Art

For the purposes of this disclosure, the terms WEDGE or

STOP are to be utilized interchangeably and are considered synonymous. Wedges and or stops are known for a variety of applications. The most common implementation of these is the typical device that is used to prevent the opening or closing of a door. Typically, a small tapered wedge or stop is forced underneath the door; in this fashion a door is held open or closed at the location required by a user's needs. Additionally, wedges are utilized in a variety of applications stopping everything from boats, planes, trailers, campers and more. Typically, a stop is placed under one or more physical contact points between the device and the floor so as to prevent translation of the device in one direction. In particular, two examples of the aforementioned follow immediately.

U.S. Pat. No. 3,664,466 to Rotheiser on May 23, 1972 teaches a one piece molded bilaterally symmetrical wheel wedge is disclosed having a central supporting web, a planar base flange perpendicular to the supporting web, a rear flange intersecting the base flange and at an acute angle therewith, and a concave upwardly facing rim flange which extends at an acute angle from the forward portion of the base flange to the upper portion of the rear flange. A plurality of generally triangular wheel grip wedges extend laterally of the base flange and the ramp flange.

U.S. Pat. No. 4,434,995 granted to Toy on Mar. 6, 1984 teaches a boat trailer specifically designed to permit retrieval thereof when the wheels rotatably mounted thereon have fallen off an underwater precipice of the type often encountered when launching a boat at a boat ramp. A pair of wedge or ramp shaped members are integrally formed with or fixedly secured to the underside of a conventional boat trailer frame, just forwardly of the trailer wheels. The respective base portions of the ramp members abut the underside of the side rails of such trailer frame, and the respective trailing edges of the ramp members depend to such base portions, just forwardly of the respective wheel members, extending to a point just below the axis of rotation of such wheel members. The respective operative surfaces of the ramp members correspond to the hypotenuse of a triangle and slidingly engage the transverse edge of the precipice when the trailer is retrieved from the water.

FIG. 1 illustrates a Prior Art stretcher device 100 having bedding, railings, support structure and wheels for the support of a patient in various medical environments (hospitals, medical office, inpatient and outpatient care). Typically, a cumbersome mechanical brake system is included within the stretcher device. However, many times nurses and other medical staff leave the braking system disengaged. Thus, in the course of a day the stretcher device 100 can move because of patient motion or as a result of impacts received from medical personnel, equipment placed in motion by medical personnel and other persons such as visitors and staff. With the stretcher 100 free to move it usually hits a barrier such as the wall 110 shown in FIG. 1; in this manner the stretcher 100 can cause damage to walls, medical devices, personnel, visitors, patients and more. This is an unacceptable defect in a medical environment. Thus, some solution is necessary to overcome this deficiency.

### BRIEF SUMMARY OF THE INVENTION

A floor mounted stopping device comprising an oblong solid material having a bottom surface and a double sided high bonding adhesive tape affixed on one side to the bottom surface; a peal away backing affixed to the other side of the double sided high bonding adhesive tape; wherein the oblong solid material is shaped as a triangle across its entire length; wherein the oblong solid material is shaped as a triangle on an end side; wherein the oblong solid material is shaped as a triangle on another end side; wherein the length of the floor mounted stopping device is greater than the distance between two wheels of a device; wherein the length of the floor mounted stopping device is greater than three feet; wherein the length of the floor mounted stopping device is at least 39 inches or greater; wherein the width of the floor mounted stopping device is such that is prepared to stop wheeled devices; wherein the width of the floor mounted stopping device is greater than three inches; wherein the width of the floor mounted stopping device is at least three inches or greater; wherein the oblong solid material has a triangular design with a flat bottom and angles inward from an edge base running the length of the device; wherein the edge base is a rounded edge base; wherein the edge base is a flat edge base; wherein the oblong solid material is made from a group of materials comprising: plastic, rubber, vinyl, metal, elastomeric materials, PVC, wood and polymers.

A floor mounted stopping device comprising an oblong solid material having a bottom surface and a double sided high bonding adhesive tape affixed on one side to the bottom surface and on the other side to the floor; wherein the oblong solid material is made from a group of materials comprising: plastic, rubber, vinyl, metal, elastomeric materials, PVC, wood and polymers;

A floor mounted stopping device comprising an oblong solid material having a bottom surface a double sided high bonding adhesive tape affixed on one side to the bottom surface and on the other side to the floor and a wheeled device in physical contact with the oblong solid material; wherein the oblong solid material has a triangular design with a flat bottom and angles inward from an edge base running the length of the device; wherein the oblong solid material is made from a group of materials comprising: plastic, rubber, vinyl, metal, elastomeric materials, PVC, wood and polymers.

### BRIEF DESCRIPTION OF THE SEVERAL VIEWS OF THE DRAWINGS

FIG. 1 illustrates the Prior Art stretcher with bedding, railings, support structure and wheels going out of control as a result of impacts or patient motion. The stretcher motion carries it against a wall or similar structure or device causing unneeded damage.

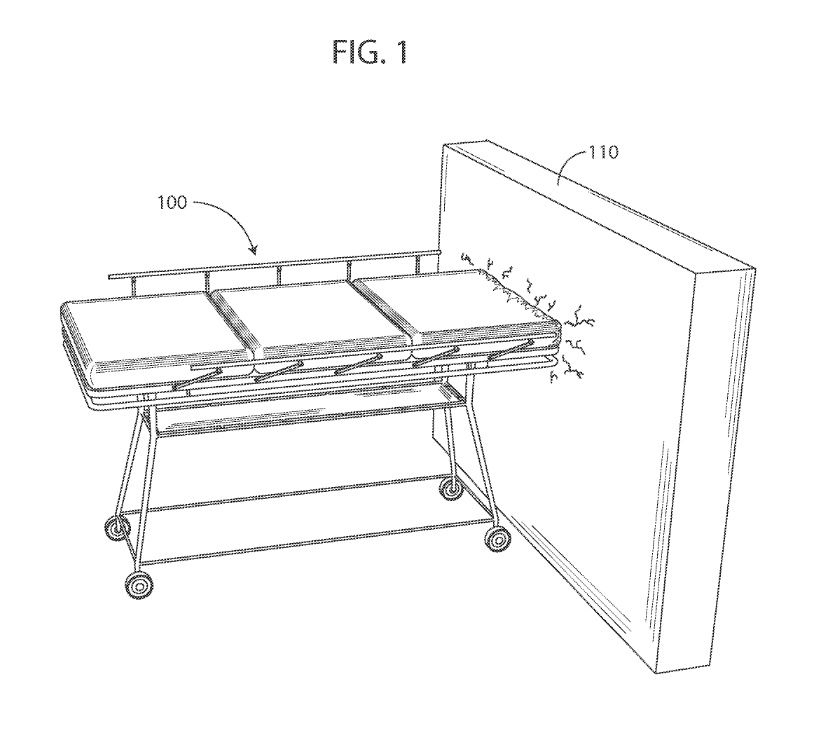

FIG. 2 illustrates the Stretcher Stopper device of the instant invention in several views including an upside down perspective. This view shows how the adhesive strip is affixed to the underside of the Stretcher Stopper device.

FIG. 3 illustrates the removal of an adhesive strip placed on the back of the Stretcher Stopper device by a user grasping the edge of the device and removing it from the Stretcher Stopper back plane.

FIG. 4 illustrates how a user positions and places the Stretcher Stopper device on the floor.

FIG. 5 illustrates how a Stretcher Stopper device is placed FIG. 5A in front of a stretcher that is in motion heading in the general direction of the floor mounted Stretcher Stopper device. The stretcher makes contact with the Stretcher Stopper device in FIG. 5B and FIG. 5C more clearly shows how the entire system stops the forward motion of a stretcher.

### DETAILED DESCRIPTION OF THE INVENTION

The invention has thus been described in such clear and precise terms as to enable one of ordinary skill in the art to understand its fundamental principles.

The Stretcher Stopper as envisioned by inventor is a floor mounted bed/stretcher stopper device. The device is made from a variety of individual or combinations of materials. Amongst these are high strength vinyl that is resistant to high impact loads, PVC, plastic, rubber, vinyl, metal, elastomers, polymers and more in a variety of colors. The stopper device as taught herein takes a short period of time to install since the installation requires the removal (peeling) of the plastic backing from the double sided high bonding adhesive tape and the sticking of the device on to the working surface, typically the floor of a medical or hospital environment. In the event the device needs cleaning, that pre-step can also be included; however, as is very clear it is a short but sometimes necessary step to the installation of the device. In addition to the foregoing, the device needs neither screws nor tools for its installation. It is easy to clean and buff around once installed since it provides for a well-defined boundary on the floor and holds up against various harsh medical and hospital environments because of its rugged construction. Thus, the device is resistant to various factors such as moisture and chemicals. Finally, the device is easily removable and reusable in the event that a rearrangement of the floor is necessary, a common occurrence in medical and hospital locales.

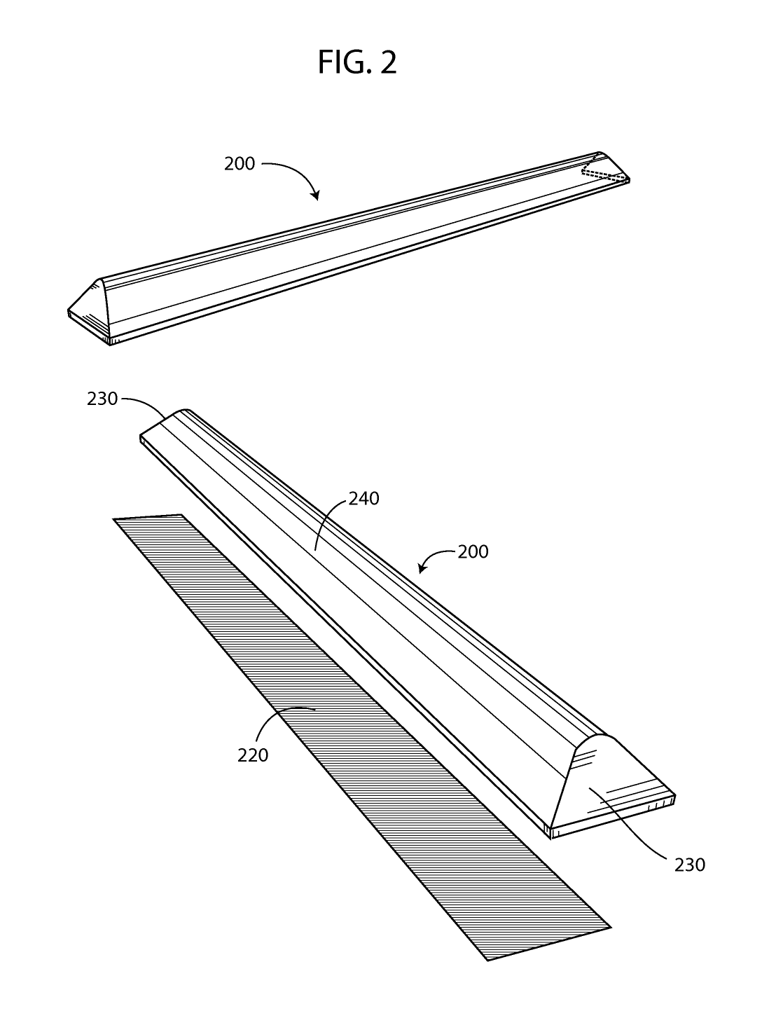

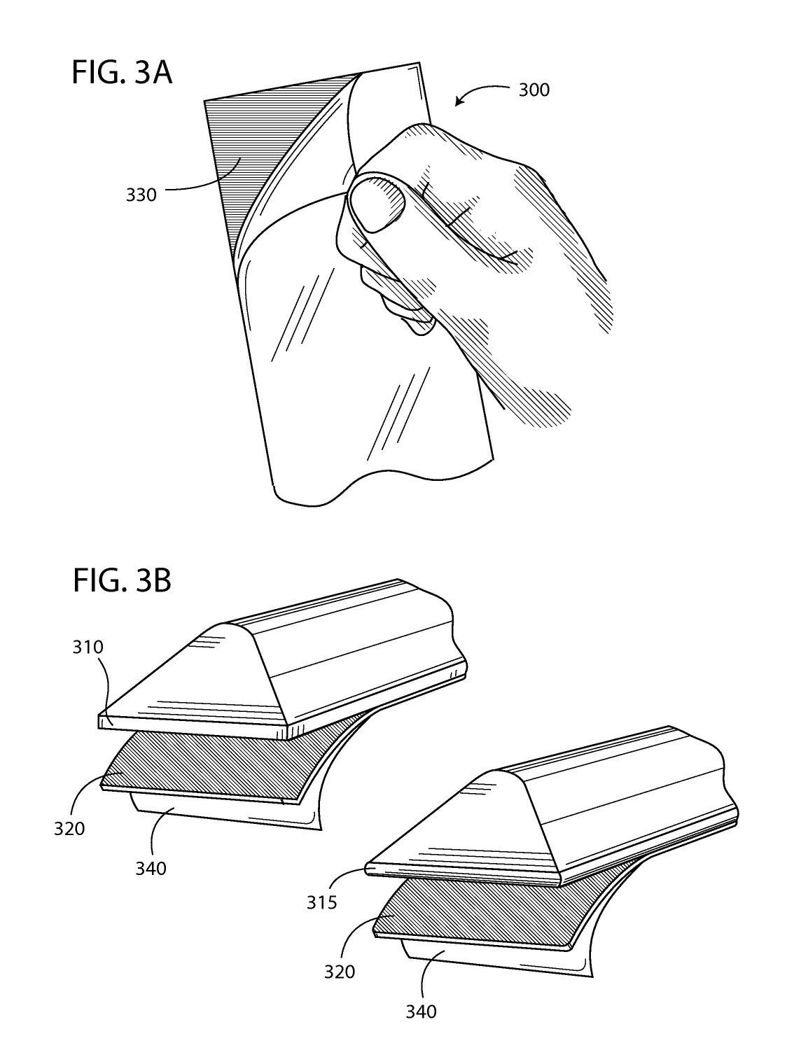

FIG. 2 illustrates the Stretcher Stopper device 200 of the instant embodiment in several views including an upside down perspective. This view shows how the adhesive strip is affixed to the underside of the Stretcher Stopper device. FIG. 2 illustrates how the stretcher stopper of the instant embodiment is formed from a solid piece of material in an oblong triangular shape as shown; the device proceeds from the two sloped sides 240 to either end of the two sloped triangular ends 230. When turned upside down the device has an oblong rectangular shape having double sided high bond adhesive tape 220 affixed thereon. One side of the double sided high bond adhesive tape 220 is attached to the underside of the device and the other side has a peal away backing attached thereto that is shown more clearly with respect to FIG. 3. When the backing is removed the entire device can be placed on the floor with sufficient bonding strength so as to prevent the motion of a stretcher or similar medical device, diagnostic equipment and or wheel chair. The sides of the Stretcher Stopper are sloped downwards from a rounded or flat central edge towards (this acts as a long apex, radius, or vertex for the device) either of the two large oblong sides 240 and the two small end sides until the bottom part of the device is reached and the double sided high bond adhesive tape 220 is affixed thereto.

FIG. 3 illustrates the removal 300 of a peal away backing strip placed on the back 330 of the Stretcher Stopper device by a user grasping the edge of the device and removing it from the Stretcher Stopper back plane. The sloped edges of the side of the device end in an edge that proceeds around the entire stopper as shown. All four sides angle to a flat or rounded edge 310/315. When turned upside down the device has an oblong rectangular shape having double sided high bond adhesive tape 320 affixed thereon. One side of the double sided high bond adhesive tape 320 is attached to the underside of the device 330 and the other side has a peal away backing 340 attached thereto that is shown more clearly with respect to FIG. 3.

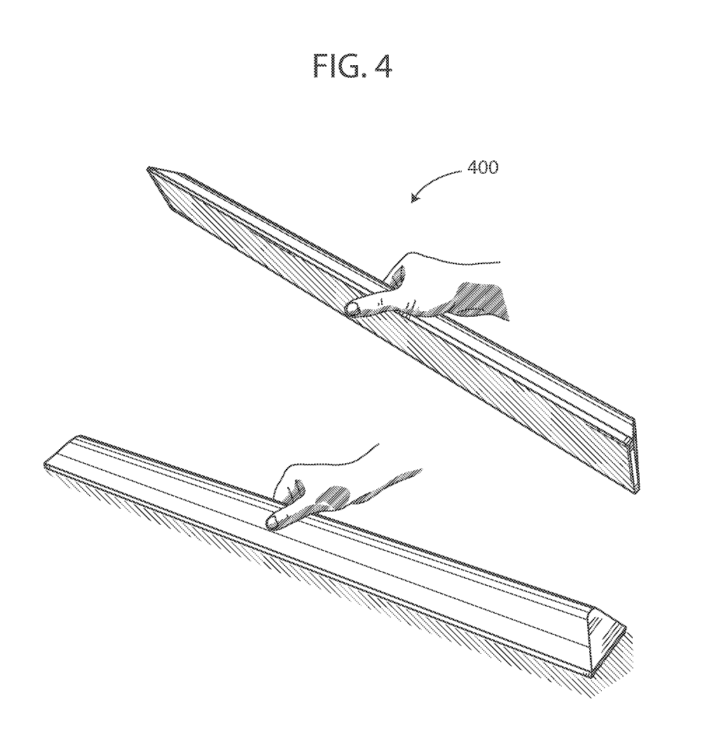

FIG. 4 illustrates how a user positions 400 and places the Stretcher Stopper device on the floor. After grasping and pealing away the backing 340 as shown in FIG. 3 the user grasps the stopper device with one or both hands and positions himself or herself in front of a location where the device should be placed. He or she then lowers the device to the floor and presses it into the floor so as to ensure a tight fit to the floor.

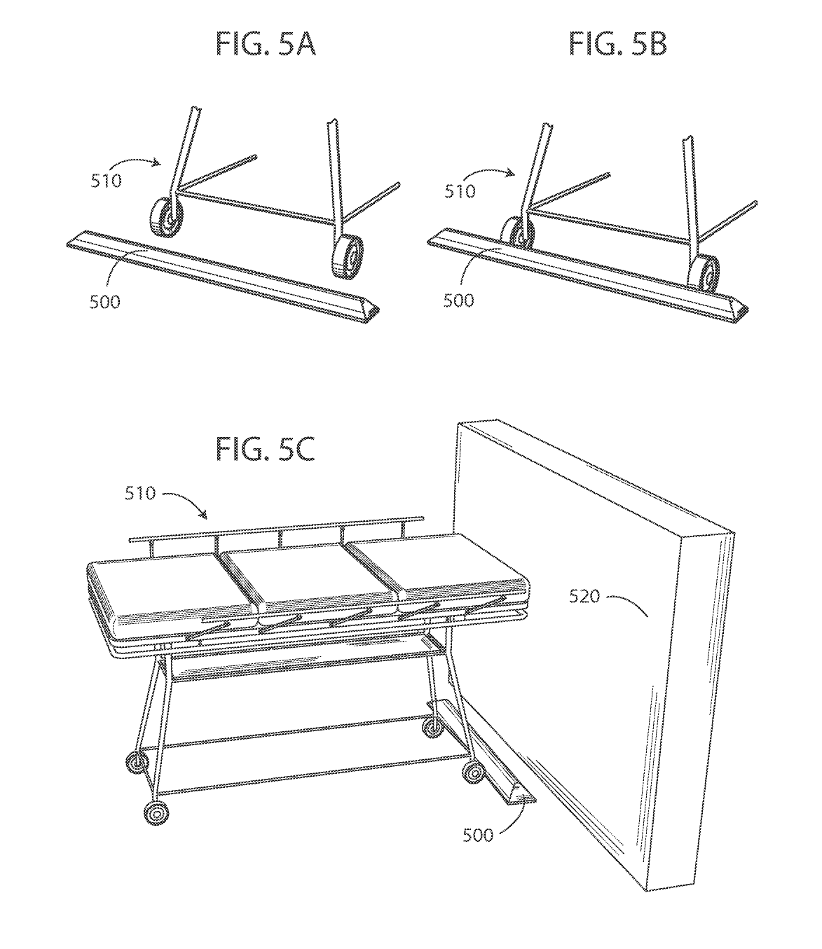

FIG. 5 illustrates how a Stretcher Stopper device 500 is placed FIG. 5A in front of a stretcher or bed 510 that is in motion heading in the general direction of the floor mounted Stretcher Stopper device 500. The stretcher 510 makes contact with the Stretcher Stopper device 500 in FIG. 5B and FIG. 5C more clearly shows how the entire system stops the forward motion of a stretcher 510 from impacting the wall 520 beyond the stopper 500. Even though the drawings illustrate a stretcher or bed 510 being prevent from further motion, it should be understood that the device is suitable for stopping any sort of wheeled equipment in a medical environment including but not limited to a stretcher, a wheelchair, a diagnostic device, a wheeled storage container and a more generally a multiple wheeled device. However, the primary use envisioned by inventor is for this device to prevent hospital beds and hospital stretchers from hitting the headwalls and vital life saving equipment in a hospital room or medical bay environment.

Final Considerations

The Stopper of the instant embodiment is a floor barrier safeguard that prevents the movement of any rolling apparatus utilized in a medical environment. The unit is one solid piece or one self-contained unit per application. The stopper unit is approximately 40 inches in length with a flat bottom (typical dimensions are over three feet in length and over two (2) inches in width; another is thirty-nine (39) inches by three (3) inches in width. The unit is angled on all four (4) sides and takes the shape of a triangle when looking at it from the ends. All four sides angle to a flat or rounded edge that forms the base of the device. When looking at the device from the front or back this edge spans the length of the unit such that the ends are angled inwards. The stopper device is made from any type plastic, rubber, vinyl, metal, elastometers, polymers in any desired color. On the flat side or underside of the unit a double sided high bond adhesive tape is attached to the unit. The side of the tape that is not attached to the unit, in other words, the outside, has a peal away backing. This backing will be removed prior to floor application of the unit.

In operation the stopper device is set in place on the floor surface in a predetermined location thereby restricting the movement of a rolling apparatus. In this manner, it prohibits the rolling apparatus from moving beyond the specified boundary of the stopper location. As a consequence of its stopping effect, the device prevents collision with other medical equipment and surrounding structures. When approaching the stopper unit, a typical rolling medical apparatus is moved perpendicularly to the stopper until the wheelbase makes contact along the length of the stopper device thereby prohibiting further motion. Because of its large length and easily visible width, the stopper also provides an alignment reference to guide the apparatus for proper location. It is hard to miss a large triangular piece of material on the floor in front of a person. Additionally, the stopper can not only be attached to floor with adhesive tape but it also can be attached with other type of fasteners such as nails, screws and similar fasteners. Finally, the device is easily buffed around and cleanable to prevent germ and bacteria build up and is removable with out damage to flooring; because it is easy to remove the device is reusable.

I claim:

1. A floor mounted stopping device comprising:
an oblong solid material having
a bottom surface and
a double sided high bonding adhesive tape affixed on one side to the bottom surface.

2. The floor mounted stopping device of claim 1, further comprising:
a peal away backing affixed to the other side of the double sided high bonding adhesive tape.

3. The floor mounted stopping device of claim 1, wherein the oblong solid material is shaped as a triangle across its entire length.

4. The floor mounted stopping device of claim 3, wherein the oblong solid material is shaped as a triangle on an end side.

5. The floor mounted stopping device of claim 4, wherein the oblong solid material is shaped as a triangle on another end side.

6. The floor mounted stopping device of claim 1, wherein the length of the floor mounted stopping device is greater than the distance between two wheels of a device.

7. The floor mounted stopping device of claim 1, wherein the length of the floor mounted stopping device is greater than three feet.

8. The floor mounted stopping device of claim 1, wherein the length of the floor mounted stopping device is at least 39 inches or greater.

9. The floor mounted stopping device of claim 1, wherein the width of the floor mounted stopping device is such that is prepared to stop wheeled devices.

10. The floor mounted stopping device of claim 1, wherein the width of the floor mounted stopping device is greater than three inches.

11. The floor mounted stopping device of claim 1, wherein the width of the floor mounted stopping device is at least three inches or greater.

12. The floor mounted stopping device of claim 1, wherein the oblong solid material has a triangular design with a flat bottom and angles inward from an edge base running the length of the device.

13. The floor mounted stopping device of claim 12, wherein the edge base is a rounded edge base.

14. The floor mounted stopping device of claim 12, wherein the edge base is a flat edge base.

15. The floor mounted stopping device of claim 1, wherein the oblong solid material is made from a group of materials comprising: plastic, rubber, vinyl, metal, elastomeric materials, PVC, wood and polymers.

16. A floor mounted stopping device comprising:
an oblong solid material having
a bottom surface and
a double sided high bonding adhesive tape affixed on one side to the bottom surface and on the other side to the floor.

17. The floor mounted stopping device of claim 16, wherein the oblong solid material is made from a group of materials comprising: plastic, rubber, vinyl, metal, elastomeric materials, PVC, wood and polymers.

18. A floor mounted stopping device comprising:
an oblong solid material having
a bottom surface
a double sided high bonding adhesive tape affixed on one side to the bottom surface and on the other side to the floor and
a wheeled device in physical contact with the oblong solid material.

19. The floor mounted stopping device of claim 18, wherein the oblong solid material has a triangular design with a flat bottom and angles inward from an edge base running the length of the device.

20. The floor mounted stopping device of claim 18, wherein the oblong solid material is made from a group of materials comprising: plastic, rubber, vinyl, metal, elastomeric materials, PVC, wood and polymers.
